(19) United States
(12) Patent Application Publication
(10) Pub. No.: US 2008/0256547 A1
(43) Pub. Date: Oct. 16, 2008

(54) Method and System For Managing a Common Resource In a Computing System

(75) Inventor: Deepak Brahmavar, Bangalore Karnalaka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 11/884,790

(22) PCT Filed: Feb. 23, 2005
(86) PCT No.: PCT/IN2005/000058

§ 371 Date: Aug. 21, 2007

(51) Int. Cl. G06F 9/50; G06F 12/14

(52) U.S. Cl. 718/104; 710/200

(57) ABSTRACT

The invention, in one embodiment, provides a method for acquiring and releasing a lock over a common resource in a computing system. After a lock has been acquired over a common resource. A determination (210) is made as to whether another request for the common resource has been made. If the other request has been made (212), the lock over the common resource is released so that the common resource becomes available for use by the another request (218).

### TECHNICAL FIELD

The present invention relates to the field of managing common resources in a computing system. More particularly, but not exclusively, the present invention relates to a method and system for acquiring and releasing locks in a computing system.

### BACKGROUND

Multi-processor computing systems (i.e. systems with more than one processor) are arranged to execute multiple processes or multiple threads of the same or different processes concurrently. In the remainder of this text, the terms thread and process are used interchangeably and denote a basic schedulable entity within the computing system.

During the lifetime of a process (or thread) various common (or shared) resources are accessed. A common resource is a device or software sub-system that is shared and accessed by multiple processors. An example of a common resource may be a storage device such as a hard drive or a CD-ROM drive. Most common resources can only interact with a processor in a serial fashion (i.e. the common resource can only process one request from the processor at any given time interval). Therefore, access to the common resource must be serialized in order to allow incoming requests to be serviced in a mutually exclusive manner.

One device utilized to serialize access to a common resource is a “lock”. A lock is a software flag or switch, which can be set to let a processor know whether a common resource is being utilized by another processor. When a processor (on behalf of the process it is executing) attempts to access a common resource, it will firstly acquire a lock. Once the processor has acquired the lock, other processors know that they cannot access the common resource until the lock is released. This avoids conflicts or the reading/writing of incorrect data.

The manner in which a processor checks to determine whether a common resource is locked may be broadly classified into a number of categories, including:

Spin locks: If a processor attempts to acquire a lock, but is unable to, the processor begins to loop. In each pass through the loop, the processor attempts to acquire the lock. This processor remains in the loop until the process obtains ownership of the lock.

Blocking locks: If a processor attempts to acquire a lock but is unable to, the process is placed into hibernation. The process is explicitly woken up when ownership of the lock is relinquished. Two context switches need to be performed (once during the block operation leading to hibernation and later for unblocking the thread) during this operation.

Combination locks: for which processes can selectively spin or block.

### SUMMARY

The invention, in one embodiment, provides a method for acquiring and releasing a lock over a common resource in a computing system. After a lock has been acquired over a common resource, a determination is made as to whether other requests for the common resource have been made. If other requests have been made, the lock over the common resource is released so that the common resource becomes available for use by the other requests.

### DETAILED DESCRIPTION OF THE DRAWINGS

Features of the present invention will be presented in a description of an embodiment thereof, by way of example only, with reference to the accompanying drawings, in which:

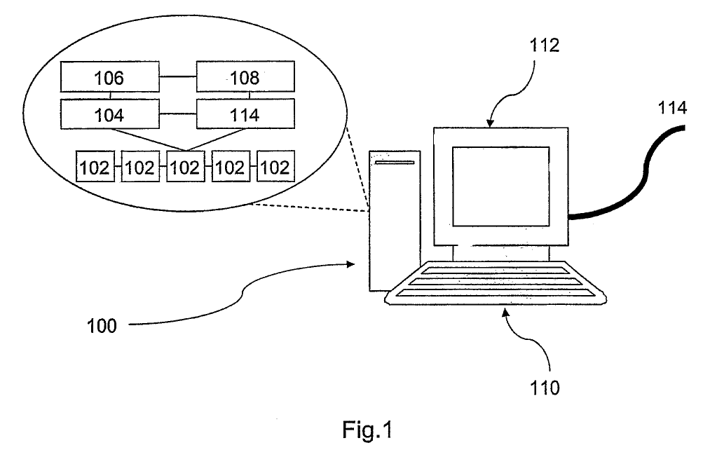

FIG. 1 illustrates a typical computing system on which an embodiment of the invention may be implemented; and

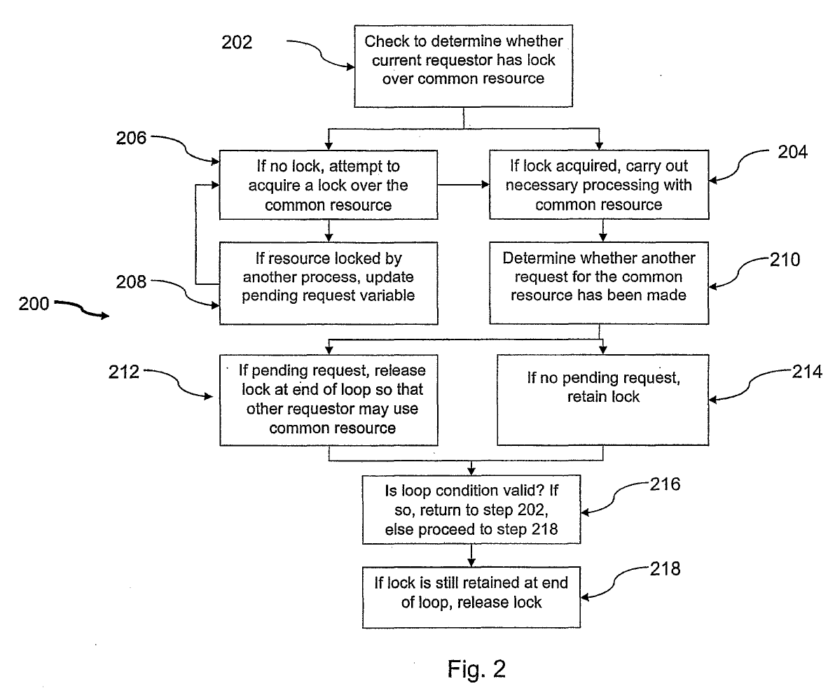

FIG. 2 is a flow chart illustrating the method steps of an embodiment of the invention.

### DESCRIPTION OF A SPECIFIC EMBODIMENT

The embodiment described herein is directed to a system and method for managing a common resource, and in particular to a system and method for acquiring and releasing locks. The embodiment is typically coded as a routine or a number of routines in a software application (such as an operating system). However, it may also be embodied in hardware, for example in firmware in a hard disk controller.

FIG. 1 shows a schematic diagram of a computing system 100 suitable for use with an embodiment of the invention. The computing system 100 may be used to execute any appropriate applications. The computing system 100 includes multiple processors 102, and may also include read-only memory (ROM) 104, random access memory (RAM) 106, and input/output devices such as disk drive 108, keyboard 110, mouse (not shown), display 112, printer (not shown), and communications link 114. The computer includes applications that may be stored in RAM 106, ROM 104, or disk drives 108 and may be executed by the processor 102. The communications link 114 connects to a computer network but could be connected to a telephone line, an antenna, a gateway or any other type of communication channel. Disk drive 108 may include any suitable storage media, such as, for example, floppy disk drives, hard disk drives, CD ROM drives or magnetic tape drives. The computing system 100 may use a single disk drive 108 or multiple disk drives. The computing system 100 may use any suitable operating system, such as Windows™ or Unix™.

It will be understood that the computing system described in the preceding paragraphs is illustrative only, and that embodiments may be executed on any suitable computing system, with any suitable hardware and/or software.

In order to more clearly describe the embodiment, an example of a typical set of lock acquisition and release software routines will be given. Subsequently, a set of software routines in accordance with an embodiment of the invention will be presented, so that the skilled addressee may understand how the embodiment is enabled.

The pseudo code segment shown below provides an example of the type of loop structure in which a lock is acquired and released during each iteration of a loop in a segment of program code:

```
loop (condition) {
    acquire_lock(mylock);
    do some processing;
    release_lock(mylock);
}
```

The lock is acquired each time the loop is entered and released at the exit of each loop. The common resource is released at the end of each loop to allow another process to access the common resource, if that is desired.

The embodiment described as follows, allows a processor (executing a process or thread) to hold a lock and retain ownership of the lock until a new request for the lock arrives.

The embodiment finds application in situations where a lock is repeatedly acquired and released and may find particular application in low contention situations. A low contention situation is one where there is a low probability that another processor will require access to the common resource. The described embodiment thus results in postponing the release of the lock when there are no new requests and this may result in fewer acquire and release operations being performed.

The embodiment ameliorates the need to acquire and release the lock for every iteration of the loop. The method steps are shown in flow chart 200 of FIG. 2.

At step 202, a check is made to determine whether the current requester of the lock already has acquired the lock over the common resource (say, from a previous iteration of the loop). If so, then no action need be taken and the necessary processing can be carried out at step 204.

If the current requestor does not hold the lock over the common resource, then an attempt is made to acquire the lock over the common resource (step 206). If the lock is successfully acquired, then the method proceeds to step 204 (carrying out the interaction with the common resource).

If, however, the resource has been locked by another processor, then the pending request variable is updated at step 208 (indicating that there is a pending request for the lock) and the method returns to step 206 and attempts to access the lock again.

Returning to the scenario where lock acquisition has been successful and the necessary processing has been carried out (namely step 204), the method then proceeds to step 210 to ascertain whether there is a pending request for the lock. If there is a pending request, the method proceeds to step 212, where the lock is released so that another processor may acquire the lock and utilize the common resource. If not, then the method proceeds to step 214, where the lock is retained, so that it will be available for use at the next iteration of the loop. Once step 212 or 214 is carried out by the method, the method then proceeds to step 216, where a check is made to see whether the loop condition is still valid. If so, then the method returns to step 202. Otherwise, the method proceeds to step 218, where a check is made to determine whether the lock has been released. If not, the lock is released so that other processors may acquire the lock and access the common resource.

The pseudo code provided below embodies the steps outlined above:

```
lock_acquire(lock)
{
    if (lock already held) {
        return;
    } else while (test_and_set(lock)) {
        set pending request field;
    }
    clear pending request field;
}
```

The lock is released only if no new request for the lock has arrived. Otherwise, the processor continues to hold the lock at the exit from the release primitive, as shown in the pseudo code below:

```
lock_release(lock)
{
    if (pending request field is set) {
        release lock;
    }
}
```

Once the loop has finished executing, a post lock release function releases the lock if it has not already been released by another request, so that the process does not maintain ownership of the lock beyond the last pass of the loop.

The post release lock function is outlined in the pseudo code below.

```
post_lock_release(lock)
{
    if (lock is currently being held) {
        release lock;
    }
}
```

Therefore, a loop structure incorporating the embodiment becomes:

```
loop (condition)
{
    acquire_lock(mylock);
    one or more statements;
    release_lock(mylock);
}
post_lock_release(mylock);
```

Further features can be incorporated to provide for different locking modes (i.e. normal release mode locks and deferred release mode locks). That is, the embodiment may be arranged to dynamically switch modes at runtime based on usage patterns. This allows the user to specify the desired release mode depending upon the profile of the incoming process.

The optimization mechanism described in this document is not restricted to spinlocks alone and can be utilized with other synchronization mechanisms.

For example, the same methodology may be utilized in an application where blocking locks are utilized. The loop structure utilizing a typical blocking lock is similar, and appears as follows:

```
loop (condition) {
    acquire_lock(mylock);
    do some processing;
    release_lock(mylock);
}
```

The embodiment for blocking locks, in a similar manner to the embodiment for spinlocks, utilizes an additional pending request variable. However, unlike the spin lock, when a thread blocks it is unable to repeatedly set the pending variable until it acquires the lock. Hence, the pending variable can be implemented as a counter for the purpose of storing the number of requests pending.

When the blocking lock is to be acquired, a similar sequence is followed. Namely, if the lock is already acquired, no action is necessary, and the function returns, as follows:

```
acquire_blocking_lock(bl_lock)
{
    if (lock already owned)
        return;
    } else if (lock is not free) {
        increment pending variable;
        sleep;
    }
    decrement pending variable;
}
```

Similarly, when releasing the blocking lock:

```
blocking_lock_release(bl_lock)
{
    if (value of pending variable > 0) {
        release lock;
        wakeup;
        }
}
```

There is also provided a routine to release the blocking lock at the end of the last iteration through the loop, namely:

```
post_blocking_lock_release(bl_lock)
{
    if (lock still owned by the caller) {
        release lock;
        wakeup;
    }
}
```

As with the spin lock embodiment, the lock is released at the exit of the loop, so that other processes may access the common resource.

A simplified worked example will now be provided utilizing the spin lock embodiment described earlier, namely:

| | |
|---|---|
| loop (condition) | A |
| { | |
| acquire_lock(mylock); | B |
| one or more statements; | |
| release_lock(mylock); | C |
| } | |
| expression statement; | D |

In the example, it is assumed that there are two threads, thread X and thread Y. Each thread attempts to access the same common resource. It is assumed that thread X will iterate though the loop five times whereas thread Y will iterate only once.

For illustrative purposes, a simplified execution cycle is assumed, such that each statement in the above pseudo-code takes one cycle to complete. Also, for the sake of brevity, statement(s) between B and C have not been shown in the tables given below. Furthermore, thread Y starts execution of the loop code from the 6^{th} cycle and lock requests will be serviced in first come, first served order.

In a table format (Table 1), the described sequence appears as follows:

TABLE 1

| | Cycle | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| Thread X | A | B* | C | B* | C | B* | C | B | B | B* | C | B* | C | D |
| Thread Y | — | — | — | — | — | A | B | B* | C | D | — | — | — | — |

The asterisk (*) indicates that the thread successfully obtained the lock.

According to an existing implementation, even though thread X is the only contender for the lock until the 7^{th} cycle, thread X releases and reacquires the lock at each pass through the loop. Furthermore, once thread Y has finished executing the loop, thread X still needs to repeat the same release and reacquire sequence from cycle 10 onwards.

When implementing the spin lock embodiment described herein, the sequence remains the same. However, the number of acquires and releases decreases as shown in Table 2 below:

TABLE 2

| | Cycle | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| Thread X | A | B* | C⁺ | B | C⁺ | B | C | B | B | B* | C⁺ | B* | C | D |
| Thread Y | — | — | — | — | — | A | B | B* | C | D | — | — | — | — |

Where the cross (⁺) indicates that the release of the lock was deferred, as no new request had arrived.

As the release of the lock is deferred, there is no requirement to reacquire the lock again.

As can be seen, the embodiment, in the simplified example given, decreases the number of lock acquires and releases during the history of thread X and thread Y. In a significantly more complex example, it will be appreciated that the number of acquires and releases may be further reduced, depending on the level of contention. Therefore, the embodiment decreases the number of releases and requires necessary, and by doing so, may decrease the total processing time for a process.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for acquiring and releasing locks to manage a common resource in a computing system, comprising the steps of, after a lock has been acquired over a common resource, determining whether other requests for the common resource has been made, and if the other requests have been made, releasing the lock over the common resource so that the common resource becomes available for use by the other requests.

2. A method in accordance with claim 1, comprising the further step of, when the lock has been acquired but not released during iteration of a loop, releasing the lock at the termination of the loop.

3. A method in accordance with claim 2, comprising the further step of determining whether the other requests for the common resource have been made, by examining a pending request variable arranged to store a value indicative of whether the other requests for the common resource have been made.

4. A method in accordance with claim 2, comprising the further step of, during the step of acquiring the lock, checking to determine whether the lock is already acquired by the current requester, and if so, taking no action to attempt to acquire the lock.

5. A method in accordance with claim 3, comprising the further step of, during the step of acquiring the lock, if the lock is acquired successfully, setting the pending request variable to a value which indicates that the current lock request has been satisfied.

6. A method in accordance with claim 3, comprising the further step of, during the step of acquiring the lock, if the lock cannot be acquired, setting the pending request variable to a value which indicates that there are other pending requests for the lock.

7. A system for acquiring and releasing locks to manage a common resource in a computing system, comprising means to acquire a lock over a common resource, means to determine whether another request for the common resource has been made once the lock is acquired, and releasing means arranged to, if the another request has been made, release the lock over the common resource wherein the common resource becomes available for use by the another request.

8. A system in accordance with claim 7, comprising means arranged to release the lock at the termination of a loop, when the lock has been acquired but not released during iteration of the loop.

9. A system in accordance with claim 8, comprising the provision of means to contain a pending request variable arranged to store a value, wherein the determining means examines the pending request variable to determine whether other requests for the common resource have been made.

10. A system in accordance with claim 8, wherein the determining means determines whether the lock is already acquired by the current requester, and if so, takes no action to attempt to acquire the lock.

11. A system in accordance with claim 9, wherein, if the lock is acquired successfully, the pending request variable is set to a value which indicates that there are no other requests for the lock.

12. A system in accordance with claim 9, wherein, if the lock cannot be acquired, the pending request variable is set to a value which indicates that there are other pending requests for the lock.

13. A computer readable medium provided with program data that, when loaded onto a computing system, executes the method steps of claim 1.
